(19) United States
(12) Patent Application Publication
(10) Pub. No.: US 2013/0173564 A1
(43) Pub. Date: Jul. 4, 2013

(54) SYSTEM AND METHOD FOR DATA COMPRESSION USING MULTIPLE ENCODING TABLES

(71) Applicants: Gary Roberts, Carlsbad, CA (US); Guilian Wang, San Diego, CA (US); Frederick Kaufmann, Irvine, CA (US)

(72) Inventors: Gary Roberts, Carlsbad, CA (US); Guilian Wang, San Diego, CA (US); Frederick Kaufmann, Irvine, CA (US)

(21) Appl. No.: 13/414,768

(22) Filed: Mar. 8, 2012

Related U.S. Application Data
(60) Provisional application No. 61/580,928, filed on Dec. 28, 2011.

(51) Int. Cl. G06F 7/00

(52) U.S. Cl. 707/693; 707/E17.002

(57) ABSTRACT

A system and method for compressing and decompressing multiple types of character data. The system and method employ multiple encoding tables, each designed for encoding a subset of character data, such as numeric data, uppercase letters, lowercase letters, Latin, or UNICODE data, to perform compressions and decompression of character data. The character encoding tables are smaller than the size of the alphabet of the uncompressed strings.

### CROSS REFERENCE TO RELATED APPLICATIONS

This application claims priority under 35 U.S.C. §119(e) to the following co-pending and commonly-assigned provisional patent application, which is incorporated herein by reference:

Provisional Patent Application Ser. No. 61/580,928, entitled “SYSTEM AND METHOD FOR DATA COMPRESSION USING MULTIPLE ENCODING TABLES” by Gary Roberts, Guilian Wang, and Fred Kaufmann; filed on Dec. 28, 2011.

### FIELD OF THE INVENTION

The present invention relates to methods and systems for compressing electronic data for storage or transmission; and in particular to an improved method and system for lossless data compression utilizing multiple encoding tables.

### BACKGROUND OF THE INVENTION

The amount of data generated, collected and saved by businesses is increasing at an unprecedented rate. Businesses are retaining enormous amounts of detailed data, such as call detail records, transaction history, and web clickstreams, and then mining it to identify business value. Regulatory and legal retention requirements are requiring businesses to maintain years of accessible historical data.

As businesses enter an era of petabyte-scale data warehouses, advanced technologies, such as data compression are increasingly utilized to effectively maintain enormous data volumes in the warehouse. Data compression reduces storage cost by storing more logical data per unit of physical capacity. Performance is improved because there is less physical data to retrieve during database queries.

Character data, comprising alphanumeric data or text, must be encoded into bytes when used on a computer system. The amount of storage required for the storage of this type of data depends crucially on the encoding scheme utilized. Uncompressed character data stored within a typical database system requires one byte per character when storing most character data, and two or more bytes per character for East Asian characters. As greater amounts of data are saved within database systems, the need for compressing data, including character data, becomes increasingly vital. A more storage efficient way of encoding character data is needed.

Data storage, retrieval, and manipulation must be performed expeditiously in order to satisfy user's demands. Compressing, and particularly decompressing data must be performed with negligible effects on database and data transmission operations. Additionally, it is advantageous if the data can be manipulated in its compressed form.

Many compression schemes require a significant amount of storage overhead to provide compression, so an advantage is only realized when the strings being compressed are long. It is beneficial if a compression scheme significantly compresses short strings as well as long strings.

Described below is a character data compression scheme that provides a more storage efficient process for compressing character data, provides fast compression and decompression of data, produces a compressed data format which can be manipulated in the compressed form, and can be utilized to compress short strings as well as long strings.

### BRIEF DESCRIPTION OF THE DRAWINGS

FIG. 1 is a high-level block diagram of a database system employing data compression.

FIG. 2 is simple process flow diagram illustrating a process for compressing data for storage in accordance with the present invention.

FIG. 3 is simple process flow diagram illustrating a process for decompressing data retrieved from data storage in accordance with the present invention.

FIG. 4 is simple process flow diagram illustrating a process for compressing data for network transmission in accordance with the present invention.

FIGS. 5A, 5B, and 5C, provide example encoding tables for use in the processes illustrated in FIGS. 2, 3, and 4.

FIG. 6 is a simple flowchart illustrating a process for compressing data in accordance with the present invention

FIG. 7 is a simple flowchart illustrating a process for decompressing compressed data in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

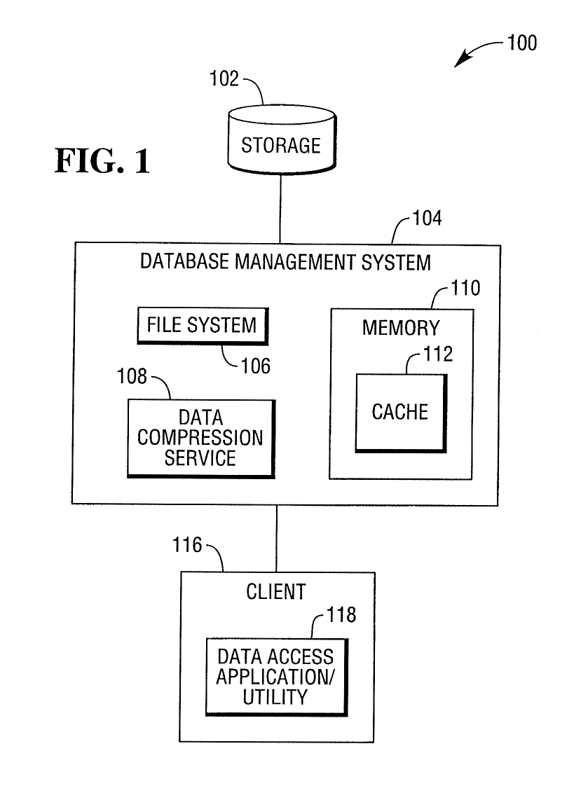

FIG. 1 is a block diagram of a database system employing data compression. The example system 100 includes a storage device 102, a database management system 104, and a client computing device 116.

The storage device 102, in some embodiments, is a hard disk resident on a computing device and can be accessed by the database management system 104. In some embodiments, the database management system 104 and the storage device are located on the same computing device, such as a server computer. In other embodiments, the storage device 102 includes one or more computing devices such as a storage server, a storage area network, or another suitable device.

The client 116, in some embodiments, is a client computer and includes a data access application or utility 118. The client 116 is communicatively coupled to the database management system 104 and may submit queries to and receive query results from the database management system 104.

The database management system 104, in typical embodiments, is a relational database management system. The database management system includes a file system 106 and a memory 110.

The memory 110 is a memory that is resident on a computing device on which the database management system 104 operates. The memory 110 is illustrated within the database management system 104 merely as a logical representation.

The memory 110 includes a cache 112 that holds transient data under control of the file system 106. Data written from the database management system 104 to storage device 102 is first written to the cache 112 and eventually is flushed from the cache 112 after the file system 106 writes the data to the storage device 102. Also, data retrieved from the storage device 102 in response to a query, or other operation, is retrieved by the file system 106 to the cache 112.

The database management system 104 includes a file system. The file system 106 typically manages data blocks that contain one or more rows of a single table. In some such embodiment, the file system 106 maintains the cache 112 in the memory 110. The cache 112 holds data blocks that have been loaded from disk or written by the database management system 104. Requests, or queries, for rows within a table are satisfied from data blocks maintained within the cache 112. Thus, when a query is made against the database, the database management system 104 identifies the relevant rows from relevant tables, and requests those rows from the file system 108. The file system 108 reads the data blocks containing those rows into cache 112. The database management system performs the query against the row or rows in the cache 112.

In some embodiments, data stored in the database may be compressed. In some such embodiments, the data stored in the database is compressed by a data compression service 108 of the database management system 104 before it is presented to the file system, and decompressed as required by the execution of a SQL request.

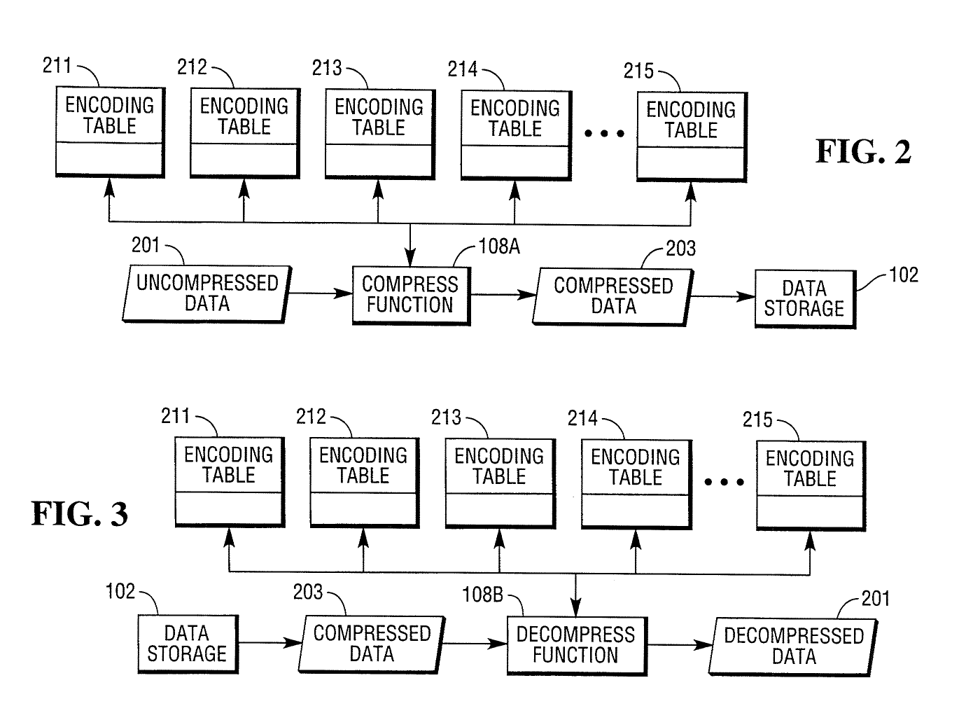

FIGS. 2 through 7 illustrate an improved process for compressing and decompressing character data for use in a data storage or transmission system. Advantages of the system explained in the figures and description below are based upon the following observations:
1. The number of bits required to encode a character is related to the collection of characters to be encoded; the number of bits required is the ceiling integer of the base-two logarithmic value of the collection size. For example, for an alphabet capable of handling any of the world's languages, over 64,000 characters, roughly 16 bits per character are required; but for an alphabet consisting of just ‘0’ and ‘1’, a single bit can encode a character;
2. Character strings exhibit locality. Even if the string as a whole contains many different characters, a small subset of characters is often sufficient locally; and
3. Several small subsets of characters can be seen to occur locally in many strings across many data sets.
4. If a string consisting of an alphabet of many characters is divided into locality based substrings consisting of smaller local alphabets, then the number of bits per character decreases, with the small overhead of specifying what alphabet the local substring uses.

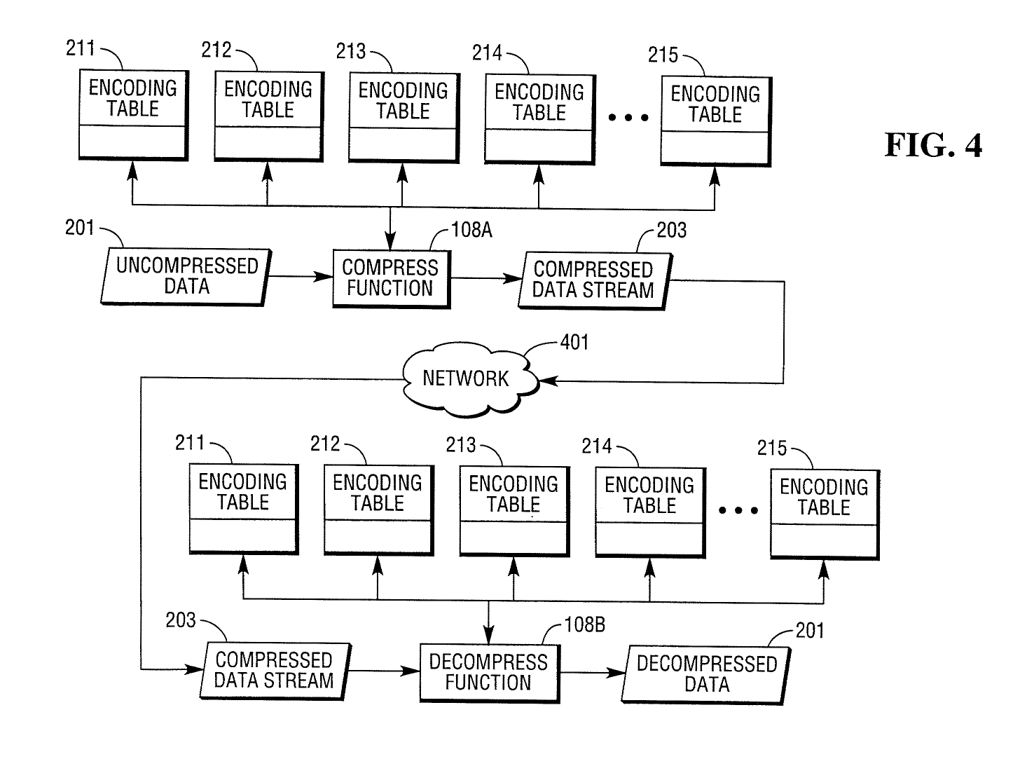

Referring now to FIG. 2, data compression function 108A employs multiple encoding tables 211 through 215 to encode uncompressed character data 201 into compressed data 203. FIG. 3 illustrates a process for decompressing compressed data 203. Decompress function 108B utilizes encoding tables 211 through 215 to re-create the original uncompressed data 201, now also referred to as decompressed data, from compressed data 203.

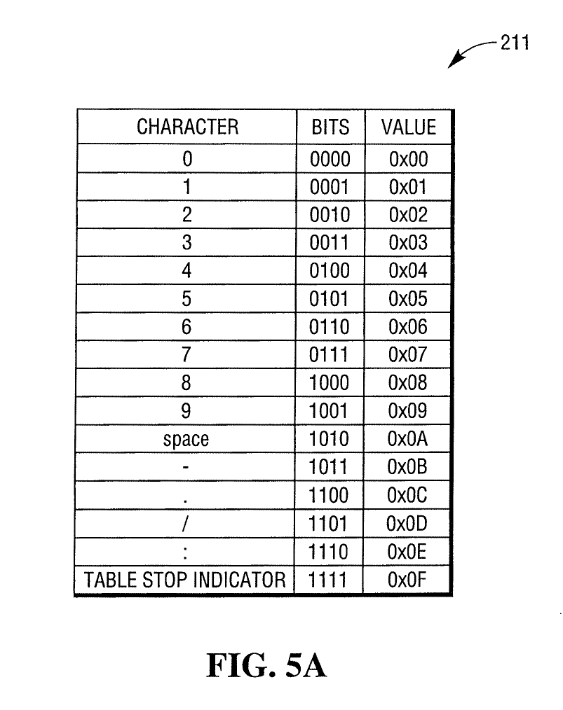

FIG. 4 illustrates the use of data compression and decompression functions described herein within a data transmission system. The data compression function 108A and encoding tables 211 through 215 operate to encode uncompressed character data 201 at one location into a compressed data stream 203 which is provided to a network 401, such as a local area network, intranet, or internet for transmission to another or multiple locations. The compressed data stream 203 received from the network is decompressed by decompress function 108B and encoding tables 211 through 215 to re-create the original uncompressed data 201 from the compressed data stream 203.

Encoding tables 211 through 215 are smaller than the size of the alphabet of the uncompressed string. The utilization of these separate smaller encoding tables for characters that occur frequently across many data sets facilitates efficient encoding of the small character subsets at the cost of some overhead switching between encoding tables.

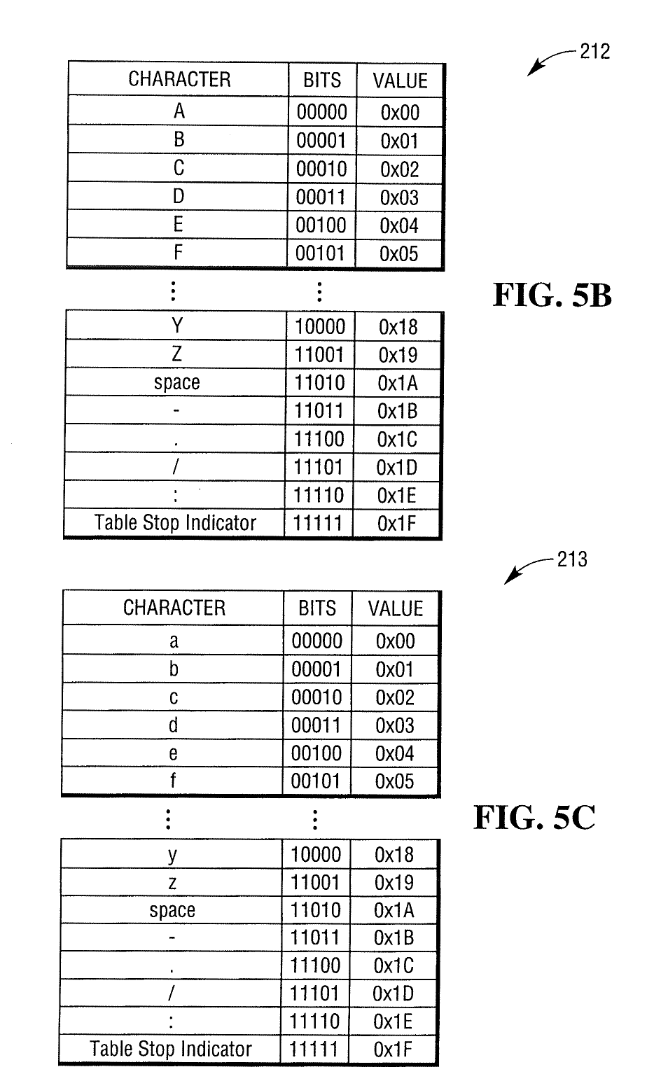

In the embodiment described herein, the five encoding tables include a numeric alphabet encoding table 211, shown in FIG. 5A; an uppercase letter alphabet encoding table 212, shown in FIG. 5B; a lowercase letter alphabet encoding table 213, shown in FIG. 5C; a Latin alphabet encoding table 214; and a Unicode Basic Multilingual Plane alphabet encoding table 215.

Numeric alphabet encoding table 211, shown in FIG. 5A, is used to encode the numerals 0 through 9, shown in the column labeled “Character”. Since there are only ten different digits, only four bits are needed for each element in this table, as shown in the column labeled “Bits”. However, there are sixteen possible combinations formed by four bits. Thus, table 211 also includes five popular punctuation characters and a table stop indicator “1111”. The inclusion of popular punctuation characters (space, “-”, “.”, “/”, “:”) helps reduce table switch overhead caused by punctuations. The table stop indicator, consisting of a bit pattern of all 1's in each encoding table in the described embodiment, is used to indicate the end of a run of characters encoded by the particular encoding table.

Uppercase letter alphabet encoding table 212 and lowercase letter alphabet encoding table 213, shown in FIGS. 5B and 5C, respectively, require the use of five bits to encode the twenty-six letters of the alphabet. As there are thirty-two possible combinations formed by five bits, leaving six combinations unused for letter encoding, tables 212 and 213 also include the five popular punctuation characters and a table stop indicator “1111” which were included in digit encoding table 211.

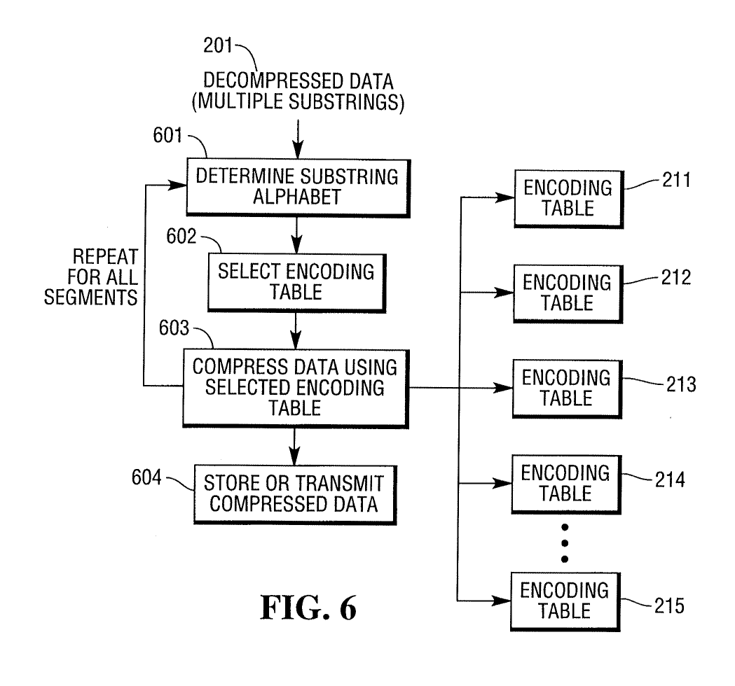

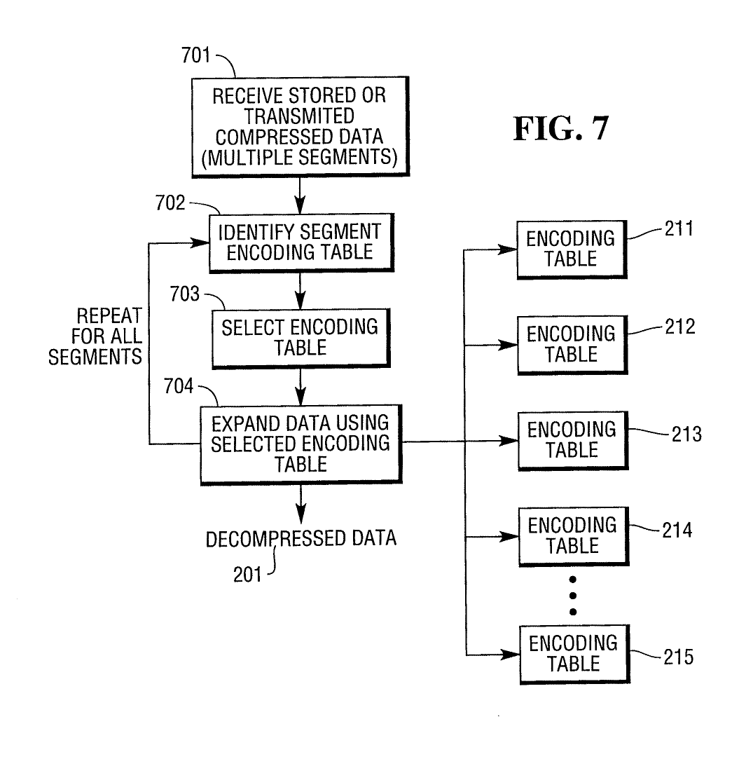

The processes for compressing character data and decompressing compressed data using the character encoding tables 211 through 215 are shown by the flowcharts illustrated in FIGS. 6 and 7, respectively.

Referring to FIG. 6, the process for compressing character data begins with the receipt of uncompressed character data string 201. Uncompressed character data string 201 will typically consist of a number of substrings having different alphabets. For each one of these substrings, the alphabet, e.g., numeric, uppercase letters, lowercase letters, Latin or Unicode, is determined in step 601. Based upon the alphabet observed, the encoding table to be used for compression is selected in step 602. Compression of the character data in accordance with the selected encoding table is performed in step 603.

In general, compression requires a careful analysis of the uncompressed character data string 201, dividing it into substrings. Each substring must be encodable by a single table. One way to divide the string into substrings is a greedy algorithm. The greedy algorithm scans through the source string. When presented with a character, it determines the smallest encoding table that includes that character. If that encoding table is currently being used, the character is simply encoded using that table. Otherwise, the current substring is terminated, and a new substring started based on this optimal encoding table.

The data when compressed using the encoding tables is composed of a sequence of segments for every continuous series of characters that belong to the same encoding table. The segments consist of an encoding table ID, the encoded characters, and the table stop indicator, as shown below:

| | | |
|---|---|---|
| Encoding Table ID | Encoded characters | Table Stop Indicator |

where:
Encoding Table ID is 4 bits and indicates which encoding table is used for this series of characters.
Encoded characters are the bits from the encoding table for this series of characters that belong to the same encoding table identified by Encoding Table ID.
Table Stop Indicator is the highest value (all 1s) in each table, which is not used for encoding any character, e.g., in digit encoding table 211 the table stop indicator is 0xF, and in uppercase and lowercase encoding tables 212 and 213 the table stop indicator is 0x1F.

Employing the compression scheme described herein, the compressed value for the character string “CA 92127-1046” is:

| Content | Value | Length in bits |
|---|---|---|
| Encoding Table ID | 0x01 | 4 |
| “CA” | 0x02001A | 15 |
| Table Stop Indicator | 0x1F | 5 |
| Encoding Table ID | 0x00 | 4 |
| “92127-1046” | 0x09020102070B01000406 | 40 |
| Table Stop Indicator | 0x0F | 4 |

The total length of the compressed value for the character string “CA 92127-1046” is 72 bits, or 9 bytes. This compares with 13 bytes for a Latin or Unicode UTF-8 encoding scheme, or 26 bytes for a Unicode UTF-16 encoding scheme.

Following encoding, in step 604 the compressed data is stored in data storage, or provided for transmission.

The process for decompressing compressed data is shown in the flowchart of FIG. 7. The process for decompressing compressed character data begins with the retrieval of compressed data from data storage or the receipt of transmitted compressed data in step 701. The compressed data may include multiple segments encoded using different encoding tables. For each segment the encoding table used for decompressing is identified from the Encoding Table ID contained in the compressed data segment, and the identified encoding table is selected for decompressing the segment in steps 702 and 703. Decompression of the compressed data in accordance with the selected encoding table is performed in step 704. This process is repeated to decompress all of the compressed data segments to yield decompressed character data 201.

Instructions of the various software routines discussed herein, such as the methods illustrated in FIGS. 6 and 7, are stored on one or more storage modules in the system shown in FIG. 1 and loaded for execution on corresponding control units or computer processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

The foregoing description of the invention has been presented for purposes of illustration and description. It is not intended to be exhaustive or to limit the invention to the precise form disclosed.

The number, sizes and contents of encoding tables may vary. For a specific data set, an appropriate set of encoding tables can be manually chosen or automatically generated based on the characteristics of the data, in order to achieve desirable compression rate. Meanwhile, according to the above observation 3, some algorithms can be created with general encoding tables, which will likely achieve a respectable compression rate over common character data. Hence what is proposed here is a family of compression algorithms, not just a single algorithm.

Obviously, the sample algorithm described above can be easily changed into another algorithm to better compress data that frequently switches between uppercase and lowercase letters (such as names and addresses) by combining the Lowercase Table and Uppercase Table into a single 6-bit based Mixed-case Table.

The advantages of the compression techniques described herein include:
Savings of storage space, transmission bandwidth, and processing time due to less I/Os to compress data;
Ability to compress both Latin and Unicode data;
Simple to understand;
Easy to implement;
Fast compression and decompression;
Good compression for short as well as long strings; and
Flexible and powerful, can be tailored for specific data to achieve high compression rate.

Additional alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for compressing data, the method comprising the steps of:
maintaining within a computer system a plurality of encoding tables corresponding to a plurality of alphabets;
receiving, by said computing system, uncompressed data, said uncompressed data comprising character data having one of said plurality of alphabets;
determining, by said computing system, an encoding table for said character data;
selecting, by said computing system, an encoding table from said plurality of encoding tables, said selected encoding table corresponding to the alphabet of said character data; and
compressing, by said computing system, said character data using said selected encoding table to provide compressed character data.

2. The method for compressing data in accordance with claim 1, wherein:
said alphabets include a numeric alphabet, an uppercase letter alphabet, and a lowercase letter alphabet; and
said encoding tables include an encoding table for compressing said numeric alphabet, an encoding table for compressing said uppercase letter alphabet, and an encoding table for compressing said lowercase letter alphabet.

3. The method for compressing data in accordance with claim 1, further comprising the step of:
storing the compressed character data within a data storage device.

4. The method for compressing data in accordance with claim 1, further comprising the step of:
providing the compressed character data to a network for transmission.

5. The method for compressing data in accordance with claim 1, wherein:
the compressed data includes a table ID value identifying the encoding table selected to compress said character data, and a stop code value indicating the end of compressed character data.

6. The method for compressing data in accordance with claim 5, wherein:
said encoding tables include a plurality of character values and corresponding compressed character values, and said stop code value.

7. The method for compressing data in accordance with claim 1, further comprising the step of:
decompressing, by said computing system, said compressed character data using said selected encoding table to provide decompressed character data.

8. A system for compressing data, comprising:
a database management system including a compression service that:
receives uncompressed data, said uncompressed data comprising character data having one of a plurality of alphabets;
determines the alphabet of said character data;
selects an encoding table from a plurality of encoding tables corresponding to said plurality of alphabets, said selected encoding table corresponding to the alphabet of said character data; and
compresses said character data using said selected encoding table to provide compressed character data.

9. The system for compressing data in accordance with claim 8, wherein:
said alphabets include a numeric alphabet, an uppercase letter alphabet, and a lowercase letter alphabet; and
said encoding tables include an encoding table for compressing said numeric alphabet, an encoding table for compressing said uppercase letter alphabet, and an encoding table for compressing said lowercase letter alphabet.

10. The system for compressing data in accordance with claim 8, wherein said compression service stores the compressed character data within a data storage device.

11. The system for compressing data in accordance with claim 8, wherein the compression service provides the compressed character data to a network for transmission.

12. The system for compressing data in accordance with claim 8, wherein:
the compressed data includes a table ID value identifying the encoding table selected to compress said character data, and a stop code value indicating the end of compressed character data.

13. The system for compressing data in accordance with claim 12, wherein:
said encoding tables include a plurality of character values and corresponding compressed character values, and said stop code value.

14. The system for compressing data in accordance with claim 8, wherein said compression service decompresses said compressed character data using said selected encoding table to provide decompressed character data.

15. A computer program, stored on a tangible storage medium, for compressing character data having one of a plurality of alphabets received by a computer system, the program including executable instructions that cause said computer system to:
determine the alphabet of said character data;
select an encoding table from a plurality of encoding tables corresponding to said plurality of alphabets, said selected encoding table corresponding to the alphabet of said character data; and
compresses said character data using said selected encoding table to provide compressed character data.

16. The computer program, stored on a tangible storage medium, in accordance with claim 15, wherein:
said alphabets include a numeric alphabet, an uppercase letter alphabet, and a lowercase letter alphabet; and
said encoding tables include an encoding table for compressing said numeric alphabet, an encoding table for compressing said uppercase letter alphabet, and an encoding table for compressing said lowercase letter alphabet.

17. The computer program, stored on a tangible storage medium, in accordance with claim 15, wherein said executable instructions cause said computer system to store the compressed character data within a data storage device.

18. The computer program, stored on a tangible storage medium, in accordance with claim 15, wherein said executable instructions cause said computer to provide the compressed character data to a network for transmission.

19. The computer program, stored on a tangible storage medium, in accordance with claim 15, wherein:
the compressed data includes a table ID value identifying the encoding table selected to compress said character data, and a stop code value indicating the end of compressed character data.

20. The computer program, stored on a tangible storage medium, in accordance with claim 19, wherein:
said encoding tables include a plurality of character values and corresponding compressed character values, and said stop code value.

21. The computer program, stored on a tangible storage medium, in accordance with claim 15, wherein said executable instructions cause said computer to decompress said compressed character data using said selected encoding table to provide decompressed character data.
